(19) United States
(12) Patent Application Publication
(10) Pub. No.: US 2005/0036264 A1
(43) Pub. Date: Feb. 17, 2005

(54) Electronic component assembly structures for circuit completion using magnetic connections

(76) Inventor: Raul Aguilar, Cave Creek, AZ (US)

Correspondence Address: Raul Aguilar, PMB 240, 29834 N. Cave Creek Rd. Ste 118, Cave Creek, AZ, 85331, US

(21) Appl. No.: 10/670,058

(22) Filed: Sep. 23, 2003

Related U.S. Application Data
(60) Provisional application No. 60/437,230, filed on Dec. 31, 2002.
(60) Provisional application No. 60/432,813, filed on Dec. 10, 2002.
(60) Provisional application No. 60/420,688, filed on Oct. 23, 2002.

(51) Int. Cl. H01H 47/00

(52) U.S. Cl. 361/143

(57) ABSTRACT

Assembly structures are characterized to allow electronic components quick, safe, easy to modify (manipulate by hands without tools), and visually intuitive (topographic) three-dimensional construction of circuits. The assembly structure allows an electronic component lead to connect to a neodymium iron boron magnet within the structure and extend the connection to other assembly structures having the same through a chrome steel ball magnetically attracting both assembly structures. The assembly structures house electronic components such as a resistor, capacitor, variable capacitor, inductor, diode, transistor, transformer, integrated circuit, wired battery clips, and a wired earpiece.

This application claims priority of provisional application No. 60/437,230 filed Dec. 31, 2002

This application claims priority of provisional application No. 60/432,813 filed Dec. 10, 2002

This application claims priority of provisional application No. 60/420,688 filed Oct. 23, 2002

### FIELD OF THE INVENTION

This invention relates to the field of electronic component assembly structures presently employed in circuit construction using terminals, breadboard, wire wrap, solder to wire, a printed circuit board, and connection wires into spring nodes for final products such as electronic kits.

### BACKGROUND OF THE INVENTION

Traditional approaches to connecting electronic components involve the use of terminals, a wire mesh on a breadboard, wire wrapping with a wire wrap tool, solder to a wire and an etched printed circuit board, and connection wires into spring nodes particularly used in educational experiment kits.

This assembly structure invention containing electronic components is collectively referred to as “BrainyWires” and lends itself as a quick, safe, easy to modify (manipulate by hands), and visually intuitive (topographic) three-dimensional construction of circuits. Cutting wires is not required; a wire wrap tool is not required; a soldering iron with solder is not required; the parts are able to move about unlike an assembly structure containing an electronic component fastened on a lead spring node connection panel; finally, the end points of wires are hidden to avoid finger cuts altogether.

Described is a functional and low cost variable capacitor designed to operate as a BrainyWires assembly structure. All parts described here are employed in a prototyped crystal radio able to be reassembled quickly by hand into a cube, stacked, or simple detector three-dimensional structures.

### DESCRIPTION OF THE INVENTION

EC Rod

Electronic Components with Two Leads (EC2)

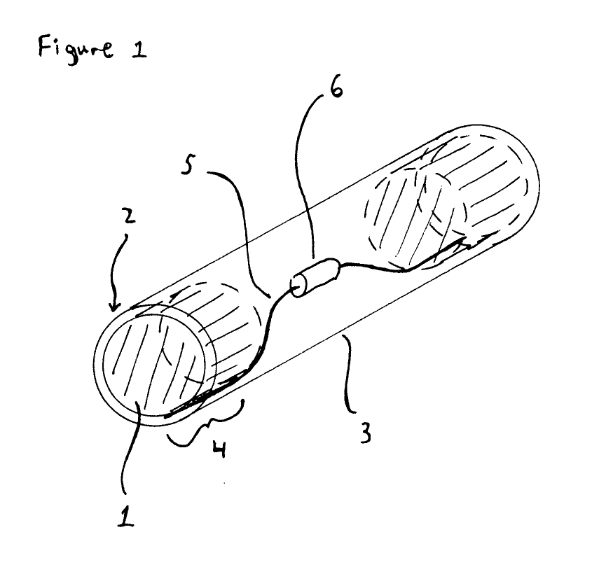

FIG. 1 is an angled view of a rod with an inserted EC2. A NIB magnet 1 is positioned against the protruding edge 2 of a Rod (a rigid vinyl tubing 3 of 3/16″ ID, ¼″ OD, and 1.0″ length). It is held firmly in place at 4 due to a wire 5 from EC2 6 without the need for adhesives (e.g. household glue) or specially designed plastic ends and with minimal distortion. The rigid vinyl tubing 3 is clear, for the purposes of easy identification of an EC2 6. As the glossary implies, any EC2, may be used such as a resistor, capacitor, or diode.

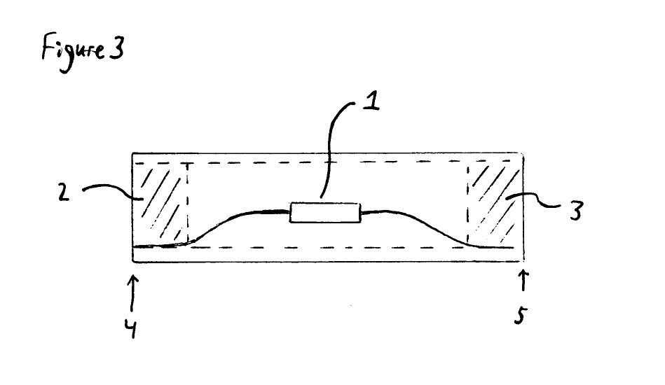

FIG. 3 is a cross section of a rod with an embedded EC2 1. NIB magnets 2 and 3 are flush against the vinyl tube at 4 and 5.

Serial EC Rod

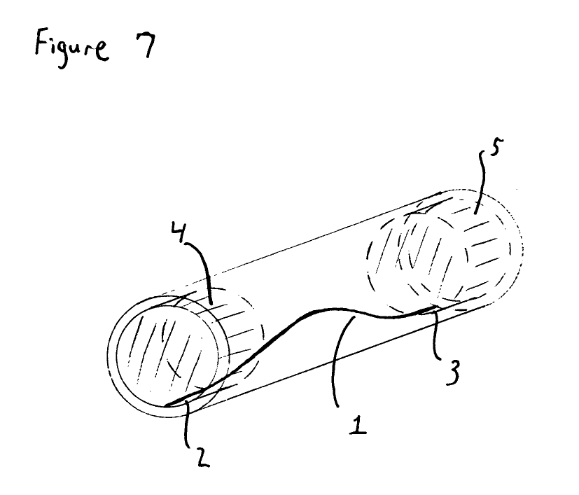

FIG. 7 shows a Serial Rod where the EC of an EC Rod is a single piece of wire wrap wire 1 completing electrical contact at 2 and 3 on NIB magnets 4 and 5. It serves the purpose of serially connecting circuit paths while maintaining a physical separation and magnetic fastening of other assembly structures.

Extruding EC Rod

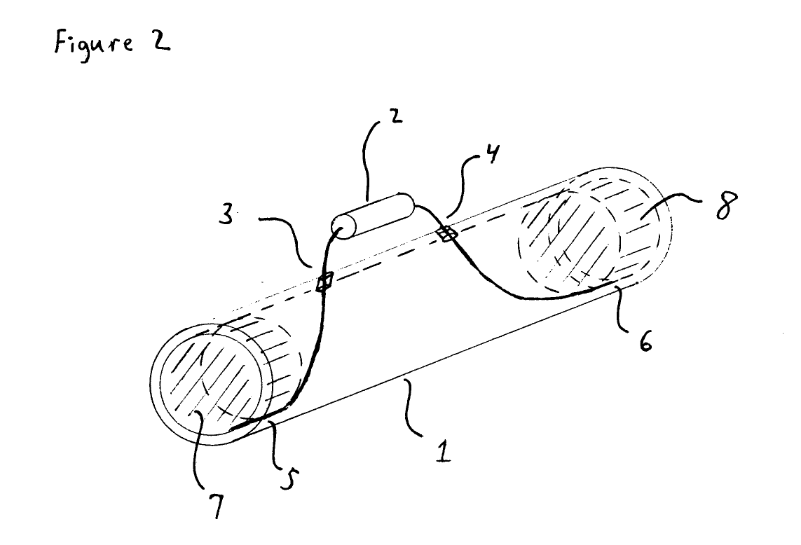

FIG. 2 is an angled view of a rod 1 with an extruding EC2 2 through two holes 3 and 4. Leads connect opposite and same radial locations 5 and 6 of the NIB magnets 7 and 8 respectively. As the glossary implies, the EC2 may be an earpiece or battery clip with long strand wires serving as the EC2 leads. One lead sockets may be substituted at holes 3 and 4.with the wire wrap wire completing the remaining connection to NIB magnets 7 and 8.

EC Panel

An Assembly Structure for Electronic Components with any Number of Leads

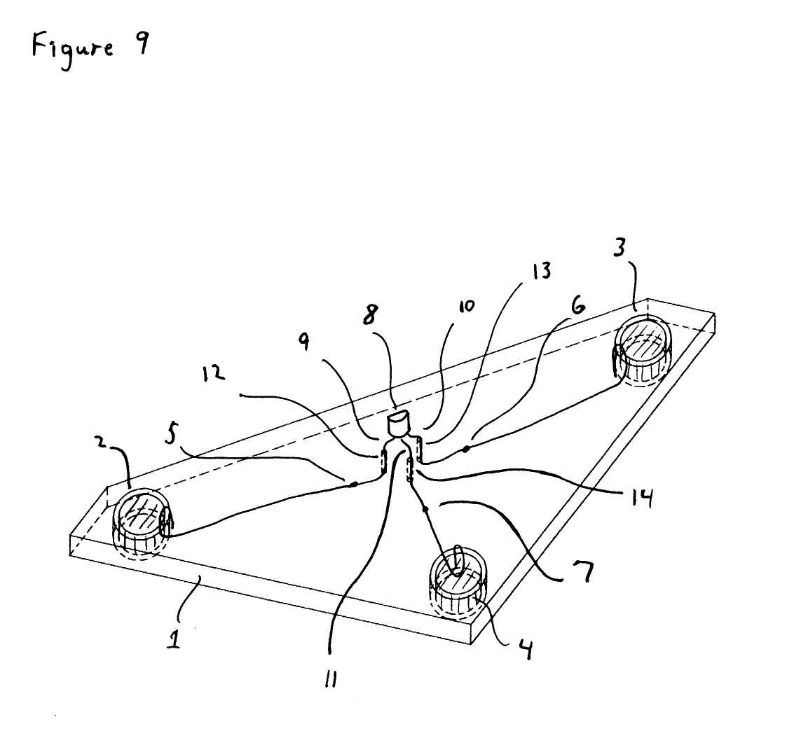

FIG. 9 is an angled view of an EC3 Panel. An example of an EC3 is a transistor. Panel 1, composed of Lexan or rigid acrylic, holds three Connector Cells 2, 3, and 4 electrically connected at 5, 6, and 7 to the EC3 (8) leads 9, 10, and 11. Holes 12, 13, and 14 allow the EC3 leads to pass-through to the bottom of the panel.

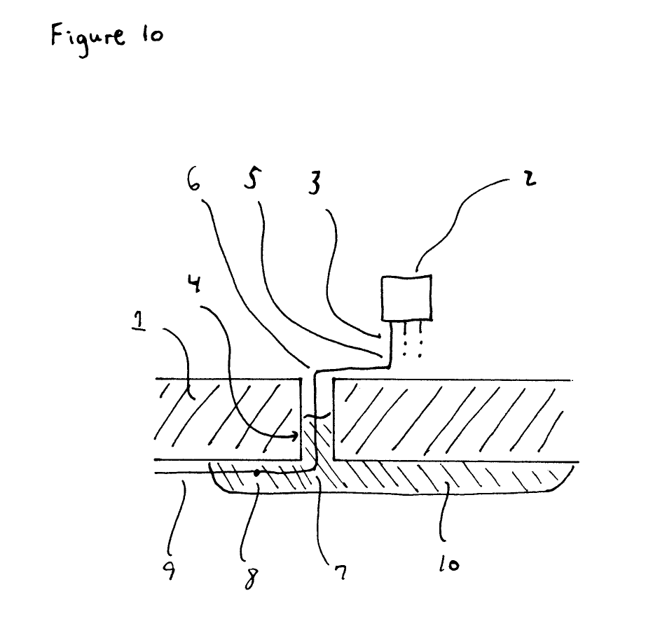

FIG. 10, is a cross section of the EC Panel 1 showing an EC 2 with only one of the EC leads 3 passing through a hole 4 of 1/32″ diameter. To prevent solder joint stress and to keep the EC3 firmly in place the lead is bent at 5, 6, and 7. The EC3 lead is soldered at 8 to wire wrap wire 9. A clear plastic epoxy 10 is cemented to shield the wire leads and wire wrap wire.

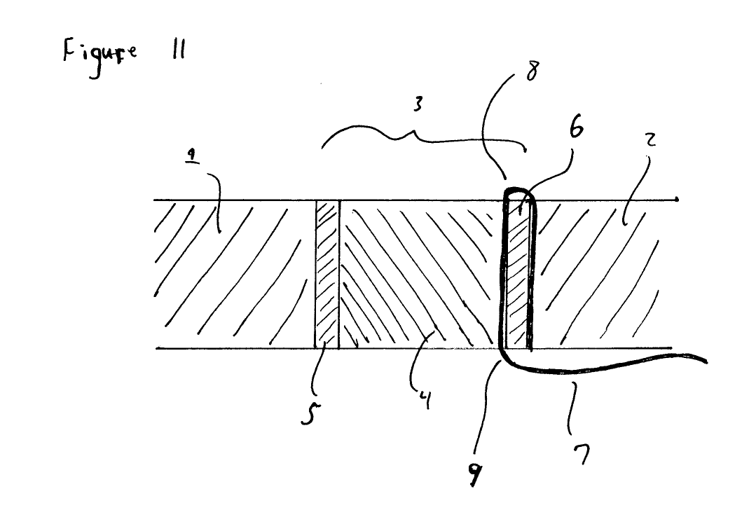

FIG. 11 is a cross section of an EC Panel Connector. 1 and 2 are the panel cross section. Connector Cell 3 (comprised of the NIB magnet 4 and soft vinyl tubing 5 and 6) electrically exposes to the top and bottom of the panel. Wire wrap wire 7 extends from an EC3 lead and wraps around a tubing cross section at 8 to provide one full turn. The wire wrap wire is stripped at 9 before coming in contact with NIB magnet 4.

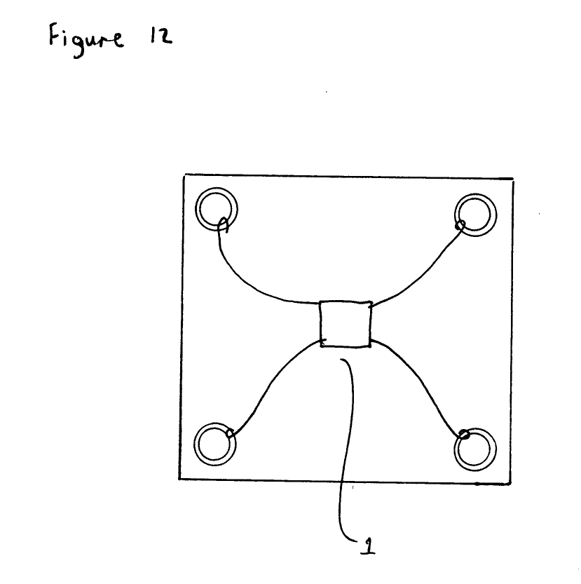

FIG. 12 is a top view of EC4 Panel to accommodate an EC4 1 having all the attributes of an EC3 Panel with the addition of a fourth EC Panel Connector.

EC Variable Capacitor

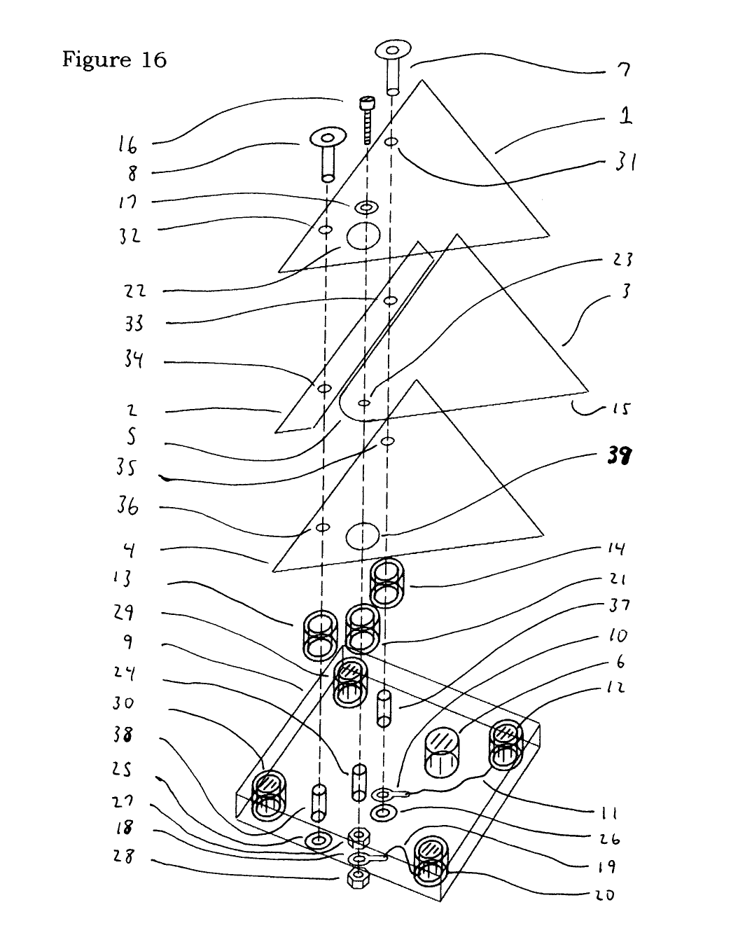

FIG. 16 is a low cost polyfilm variable capacitor designed over an EC Panel. Plate 1 is a steel sheet metal. Plates 2, 3, and 4 are aluminum sheet metal. All plates are 1/32″ thick. Plates 1, 3, and 4 are equilateral triangles with sides 2.5″. Plate 2 is a portion of the same equilateral triangle with a width of 0.25″. It is used primarily to space plates 1 and 4 while allowing plate 3 to move freely. Plate 3 is held firmly between steel sheet metal plate 1 and aluminum sheet metal plate 4. Aluminum sheet metal plate 2 provides the stop necessary to keep plate 3 at 120 degrees of circular freedom. The circular curvature at 5 allows aluminum sheet metal plate 3 to avoid contact with plate 2. NIB magnet 6 causes the magnetically attracted steel plate 1 to firmly press plates 1, 3, and 4 together. This works since aluminum plates do not absorb magnetic flux. NIB magnet 6 has dimension ¼″ diameter and ¼″ length.

Both sides of plate 2, have two layers of clear packaging tape to provide an extra thickness necessary to keep plate 3 free for movement from plates 1 and 4.

Both sides of plate 3, have one layer of clear packaging tape to provide current isolation. The tape effects a dielectric film for capacitance above and below the intersecting region of plate 3 and plates 1 and 4.

Rivets 7 and 8 (both ⅛″) provide physical rigidity to keep the variable capacitor plates 1, 3, and 4 fastened to EC Panel 9 at holes 37 and 38. Even though tape dielectric film layers electrically isolate plates 1, 2, and 4, rivets 7 and 8 electrically connect plates 1, 2, and 4 at holes 31, 32, 33, 34, 35, and 36, since the rivets expand radial when fastened by a hand held rivet tool. A complete electrical connection is made from plates 1 and 4 to the rivet, onto connector 10, soldered wire wrap wire 11, and finally to EC Cell 12 on EC Panel 9. Aluminum washers 25 and 26 (both ⅛″) fasten the rivets as well as secure an electrical connection for connector 10. Aluminum spacers 13 and 14 of ¼″ outer diameter and ¼″ length provide spacing of the plates from EC Panel 9 for agile hand manipulation of rotating plate 3. Plate 3 is rotated by hand manipulation at triangular point 15, which extends further than plates 1 and 4.

Machine screw 16 centers and pivots plate 3 through 5/64″ holes 23 and 24 and makes electrical connection of plate 3 through washer 17 (given a ¼″ diameter clearing of the dielectric film on plate 3), onto connector 18, wire wrap wire 19, and finally to EC Connector 20 on EC Panel 9. Washer 17 is sufficiently centered to prevent contact with plate 1 through ¼″ hole 22. Electrically isolating plastic tube 21 of ¼″ outer diameter and ¼″ plus 1/32″ height fits into plate 4 at hole 39 to prevent mechanical stress on center rotating plate 3. Bolts 27 and 28 keep machine screw 16 secure and aid the electrical connection of connector 18.

Though only EC Connectors 12, and 20 have an electrical connection to the EC Variable Capacitor, EC Connectors 12, 20, 29, and 30 provide the capability of external magnetic fastening to other assembly structures.

Plate 3 is allowed to move 120 degrees to provide a 30 to 370 pf capacitance, a range typically desired for a functional and low cost AM crystal radio tank circuit.

EC Coil

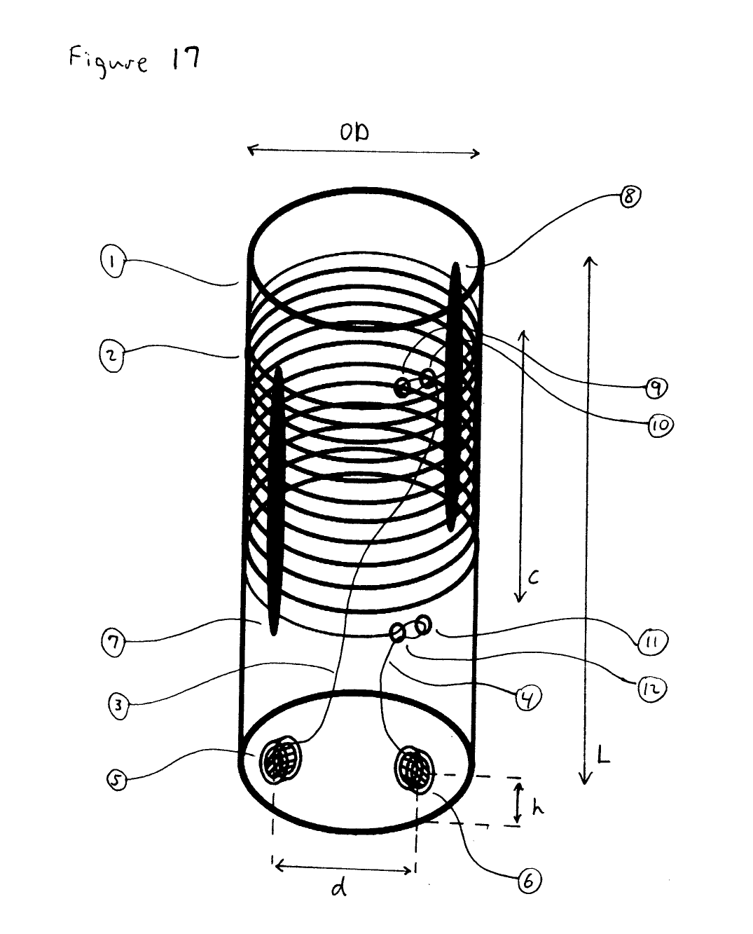

FIG. 17 is a functional and easy to snap into place coil design. A clear plastic tube 1 of outer diameter OD 1.5″, thickness 1/32″ and length L 3.75″ holds a 30 gauge magnetic wire winding 2. The magnetic wire winding 2 terminates at top holes 9 and 10 and bottom holes 11 and 12 below where at 3 and 4 the magnetic wires proceed to electrically connect to EC Connector Cells 5 and 6. The height h from the center of EC Connector Cells 5 and 6 is 7/32″ (half the diameter of a chrome steel ball) and the separation distance d (determined empirically through triangulation at 1.02″) account for magnetic fastening with chrome steel balls on a mounting EC4 Panel (not shown). A half mix of epoxy hardener and half mix of resin at 7 and 8 keep the coil firmly against clear plastic tube 1. The magnetic coil length of C at 2.875″ provides an overall coil inductance of 1022 uH.

Additional neodymium iron boron magnets held by the tension of soft plastic tubing in tube holes may provide structural support by magnetic fastening to other assembly structures.

EC Panel Separator

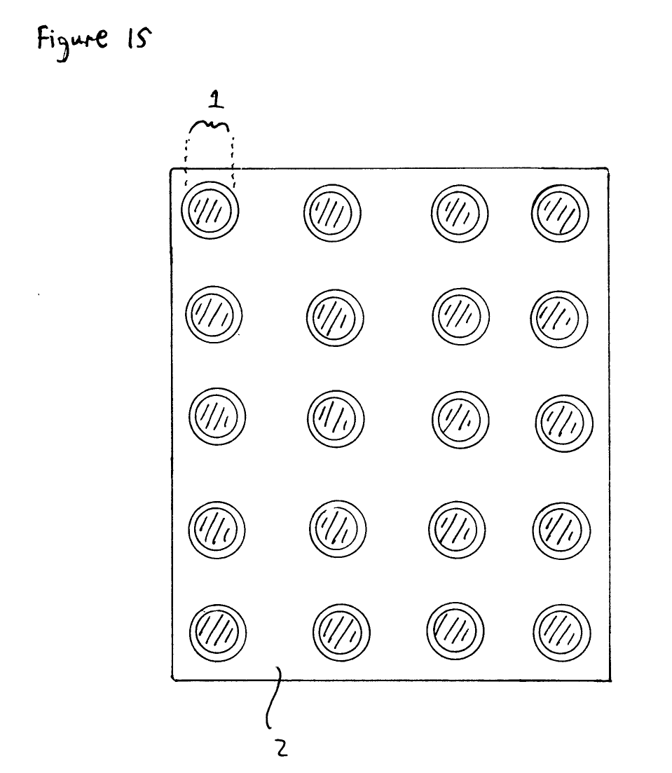

FIG. 15 is a top view diagram of an EC Panel Separator comprised of M×N Connector Cells, (one example being 1) and having no wires connected and serving the sole purpose of magnetically holding and spacing EC Rods and Panels on a Lexan or acrylic panel 2. In this example diagram M×N is 4×5.

Magnetic Connection of Electronic Assemblies

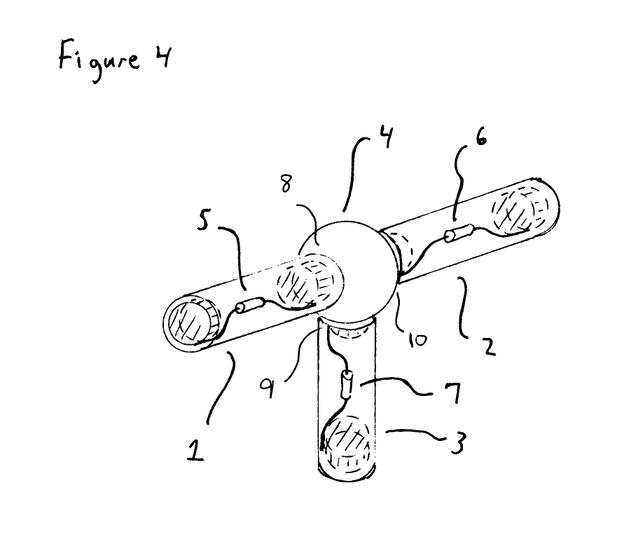

FIGS. 4 (at contact points 8, 9, 10), 6 (at contact points 7, 8, 9, 10), and 13 (at contact points 14, 15, 16, 17, 18, 19, 20, 21, 22, 23) elucidate the method of magnetically and electrically connecting neodymium iron boron magnets contained in assembly structures through structural contact of chrome steel balls.

In FIG. 4, chrome steel ball 4 of diameter 7/16″ serves the purpose of electrically connecting ECs 5, 6, and 7 while physically holding in place rods 1, 2, and 3. This is a visual improvement over a breadboard design commonplace in circuit prototyping and allows for a rapid and topologically visible three-dimensional construction of circuit design. It appeals to people learning circuit design. The 7/16″ diameter chrome steel ball accommodates a flexible non-obtrusive arrangement of EC Rods and Panels and a suitable magnetic flux attraction force per weight ratio to the NIB magnet.

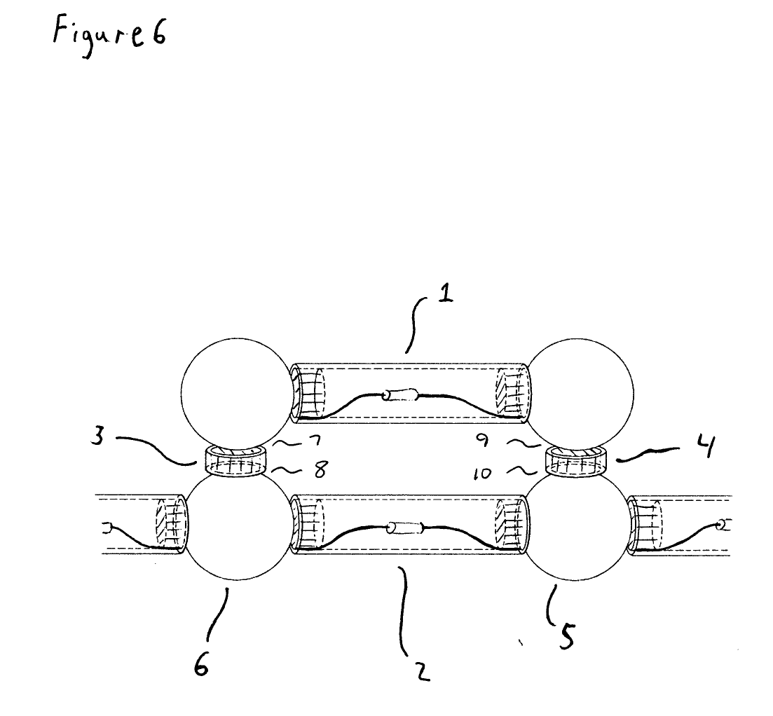

FIG. 6 shows how two EC Rods 1 and 2 are parallel connected via Connector Cells 3 and 4 while chrome steel balls 5 and 6 allow electrical continuity to other circuit EC's. By induction, any number of EC Rods may be connected in parallel.

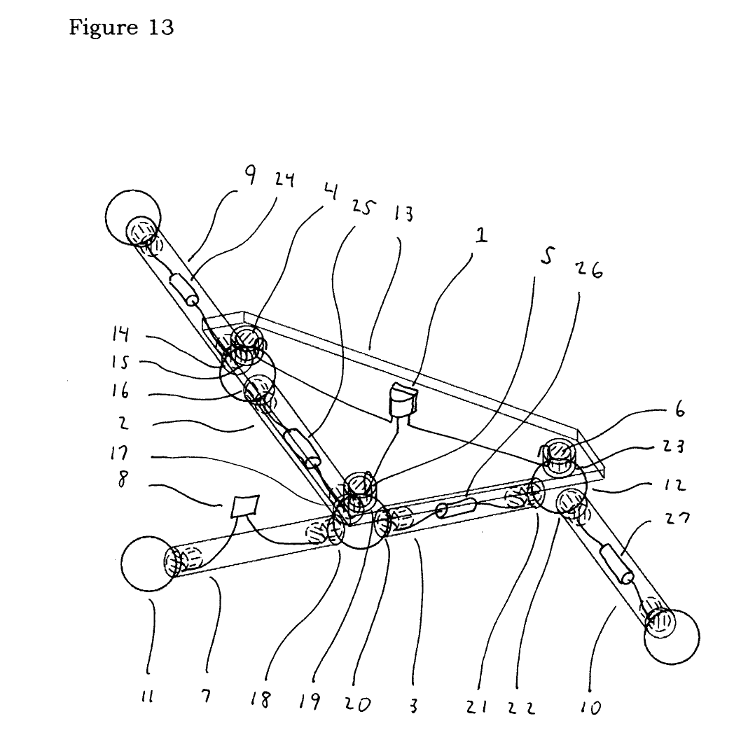

FIG. 13 depicts an example partial circuit assembly of a transistor 1 (EC3) amplifier stage on an EC Panel 13 with EC Rods 2 and 3 gaining advantage to connect below EC Panel Connector Cells 4, 5, and 6. EC Rod 7 has an extruding EC2 8. EC Rods 2, 3, 9, and 10 have embedded EC2s 25, 26, 24, and 27 respectively. The intended amplifier input and output are shown at chrome steel balls 11 and 12 respectively.

Connector Cell

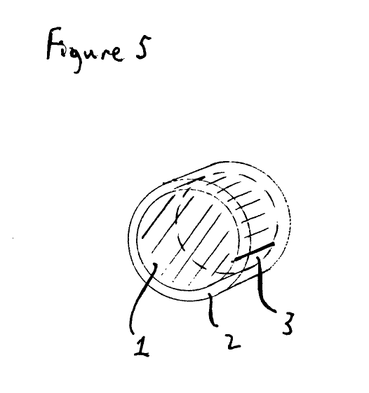

To ease parallel connections, FIG. 5 shows a short connector referred to as a Connector Cell. A NIB magnet 1 is held within a soft vinyl tube 2. The ID disparity between the NIB magnet (3/16″) and the vinyl tube (0.170″) allows the ⅛″ long vinyl tube to grasp the NIB magnet tightly. A ⅛″ long wire wrap wire 3 between the NIB magnet and the vinyl tubing adheres the NIB magnet firmly in place.

Separator Rod

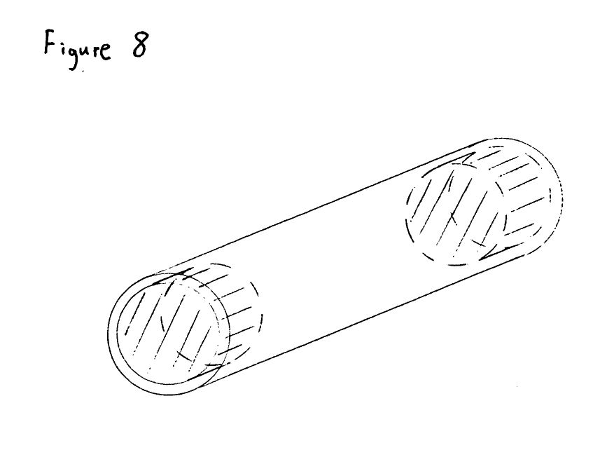

The Separator Rod in FIG. 8 contains no EC and serves the purpose of electrically isolating circuit paths while maintaining a physical separation.

EC Wire Connector

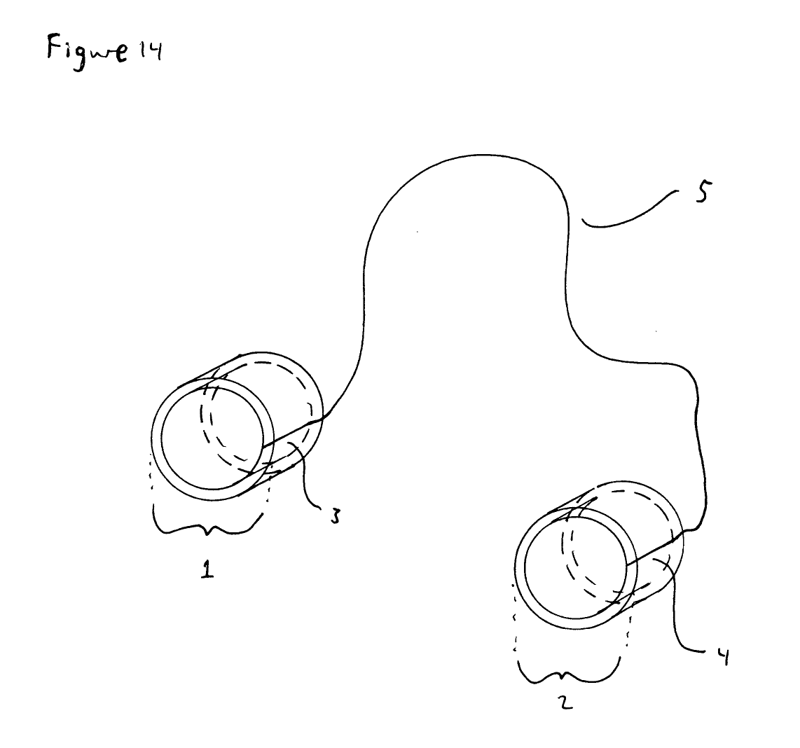

FIG. 14 is an EC Wire Connector composed of two Connector Cells 1 and 2 electrically connected at 3 and 4 respectively via wire wrap wire 5. The wire is to be provided at varied lengths to connect distinct circuit nodes.

Glossary

NIB magnet—A Neodymium Iron Boron magnet.

ID—Inner Diameter.

OD—Outer Diameter.

EC—An electronic component such as a resistor, capacitor, transistor, etc. with any number of leads.

ECn—Where n is some number, refers to an electronic component having n leads.

Rod—A rigid vinyl tube of varying length.

EC Rod—A rod containing an electrically connected EC with NIB magnets at each end.

EC Panel—A plastic panel used to hold and electrically connect ECn assembly structures.

EC Panel Connector—A soft vinyl tube wrapped NIB magnet placed in a hole within an EC Panel to allow the NIB magnet electrical exposure to the top and bottom of the panel.

Assumptions

All NIB magnets in this application are nickel plated with dimension 3/16″ diameter and ⅛″ thick unless stated otherwise.

All panels are Lexan sheets at ⅛″ thick.

All wire wrap wire is 30 gauge.

All rigid vinyl tubing has a plasticity of 75A durometer and dimension 3/16″ ID, ¼″ OD.

All soft vinyl tubing has a plasticity of 68A durometer and dimension 0.170″ ID and ¼″ OD.

All Rods are comprised of varied length rigid vinyl tubing.

ECn examples: a resistor is EC2; a transistor is EC3; and an eight lead chip such as the 1458 dual 741 op-amp is EC8; an earpiece and battery clip with long stranded wire leads are EC2.

1. Clear plastic assembly structures with fastened neodymium iron boron magnets, house and connect electronic components for ready three dimensional magnetic circuit construction.

2. The device of claim 1 wherein a clear plastic rod contains a two lead electronic component and connects the leads to neodymium iron boron magnets on both ends of the rod.

3. The device of claim 2 wherein the component is a wire connected to neodymium iron boron magnets on both ends of the rod.

4. The device of claim 2 wherein the two leads of the electronic component connect to end neodymium iron boron magnets and extrude from the clear plastic rod through one or two side wall holes.

5. The device of claim 1 wherein a clear plastic panel houses a multi-lead electronic component and connects the leads to neodymium iron boron magnets placed through holes in the panel. Each lead is held by the tension of soft plastic tubing situated between a neodymium iron boron magnet and a wall hole. Both exposed sides of the neodymium iron boron magnet within the panel allow magnetic fastening and an electrical connection.

6. The device of claim 5 wherein a clear plastic panel houses a variable capacitor comprised of one steel and two aluminum sheet metal plates with the middle aluminum plate covered with tape as a dielectric and having angular movement to vary the capacitance. The maximum capacitance of which is increased with a neodymium iron boron magnet, positioned opposite the steel plate, pulling the outer steel plate to effect close proximity of all three plates.

7. The device of claim 1 wherein a clear plastic wide tube holds magnetic wiring for induction as a coil and connects the two coil leads to neodymium iron boron magnets placed through two holes on the side of the tube. Each lead is held between the tension of soft plastic tubing situated between a neodymium iron boron magnet and a wall hole.

8. The device of claim 1 wherein a clear plastic panel contains neodymium iron boron magnets placed through holes in the panel. Each neodymium iron boron magnet is held by the tension of a soft plastic tubing situated between the neodymium iron boron magnet and it's situated hole wall. The purpose being to facilitate placement and connection of any assembly structures referenced in claims 2, 3, 4, 5, 6, and 7.

9. A method of completing electrical circuits through assembly structures fitted with neodymium iron boron magnets and containing electronic components to connect via chrome steel balls.
